(19) United States
(12) Patent Application Publication
(10) Pub. No.: US 2012/0082320 A1
(43) Pub. Date: Apr. 5, 2012

(54) WIRELESS HEADSET

(75) Inventors: Wong Hoo Sim, Singapore (SG); Thean Kuie Christopher Chang, Singapore (SG)

(73) Assignee: CREATIVE TECHNOLOGY LTD, Singapore (SG)

(21) Appl. No.: 12/896,697

(22) Filed: Oct. 1, 2010

(51) Int. Cl. H04R 1/10

(52) U.S. Cl. 381/74

(57) ABSTRACT

There is provided a wireless headset for enabling communications via a communications apparatus. The headset includes a casing for containing components of the wireless headset; a controller located within the casing, the controller being for controlling operations of the wireless headset; a wireless transceiver located within the casing, coupled to the controller for both receiving and transmitting audio data; an audio driver located within the casing, the audio driver being coupled to the controller for output of the received audio data; a first acoustic channel coupled to the audio driver at a first end, the first acoustic channel allowing transmission of output from the audio driver; and a first ear bud piece coupled to a second end of the first acoustic channel, the first ear bud piece being able to be mounted onto a user-facing surface of the casing.

### FIELD OF INVENTION

The present invention relates to the field of personal communication devices, primarily in relation to a wireless headset.

### BACKGROUND

The prevalence of portable handheld devices for uses like, for example, communications purposes, entertainment purposes and the like has correspondingly led to an increase in a number of wireless headsets usable with the portable handheld devices. Wireless headsets are popular because users have the convenience of not having to deal with wires latched to the portable handheld devices while using the headsets.

However, it is a common complaint that users of wireless headsets experience discomfort during use of the wireless headsets. The forms of discomfort may typically include, for example, headaches, heat from the headsets at a localized area where a transceiver of the wireless headsets is located, strain felt at the ear where the wireless headsets is worn and so forth. A primary cause of the discomfort stems from radiation received/transmitted at the transceiver during use of the wireless headsets. It would be preferable if the transceiver was locatable away from the users' head during use of the wireless headsets such that the existence of a tangible physical distance between the transceiver and the user's head is able to minimize discomfort experienced during use of the wireless headsets.

### SUMMARY

There is provided a wireless headset for enabling communications via a communications apparatus. The headset includes a casing for containing components of the wireless headset; a controller located within the casing, the controller being for controlling operations of the wireless headset; a wireless transceiver located within the casing, coupled to the controller for both receiving and transmitting audio data; an audio driver located within the casing, the audio driver being coupled to the controller for output of the received audio data; a first acoustic channel coupled to the audio driver at a first end, the first acoustic channel allowing transmission of output from the audio driver; and a first ear bud piece coupled to a second end of the first acoustic channel, the first ear bud piece being able to be mounted onto a user-facing surface of the casing. It is preferable that the first acoustic channel is flexible.

The casing may include either a groove for coiling the first acoustic channel or a coiling mechanism for the first acoustic channel.

Preferably, the wireless transceiver employs wireless technology such as, for example, Bluetooth, RF, IR and so forth.

The first ear bud piece may fit within a diameter of a user's first ear canal. The first acoustic channel coupled to the first ear bud piece is preferably both coiled and mounted on the casing in a first mode, and both uncoiled and dismounted from the casing in a second mode. During instances of use of the wireless headset, the casing may be located close to a user's head in the first mode, and a distance away from the user's head in the second mode. The first ear bud piece may be mounted on the casing in the first mode using a mounting technique such as, for example, magnetic attraction, friction-fit, snap-fit, screw-fit and so forth.

It is advantageous that radiation received/transmitted at the wireless transceiver within the casing is minimized at the user's head in the second mode. Furthermore, effects from any heat generated within the casing are also minimized at the user's head in the second mode.

The wireless headset may further include a microphone coupled to the controller on the user-facing surface of the casing.

The wireless headset may also include during the second mode a second acoustic channel coupled to the audio driver at a third end of the second acoustic channel; and a second ear bud piece at a fourth end of the second acoustic channel. The second ear bud piece may preferably fit within a diameter of the user's second ear canal. It is preferable that the second acoustic channel is flexible.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a schematic figure of the present invention.

FIG. 2 shows a perspective view of a physical embodiment of the present invention in a first mode.

FIG. 3 shows a perspective view of the physical embodiment of the present invention in a second mode.

### DESCRIPTION OF PREFERRED EMBODIMENTS

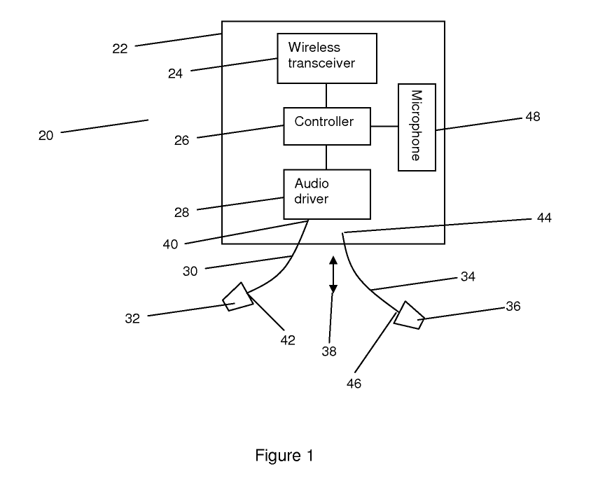

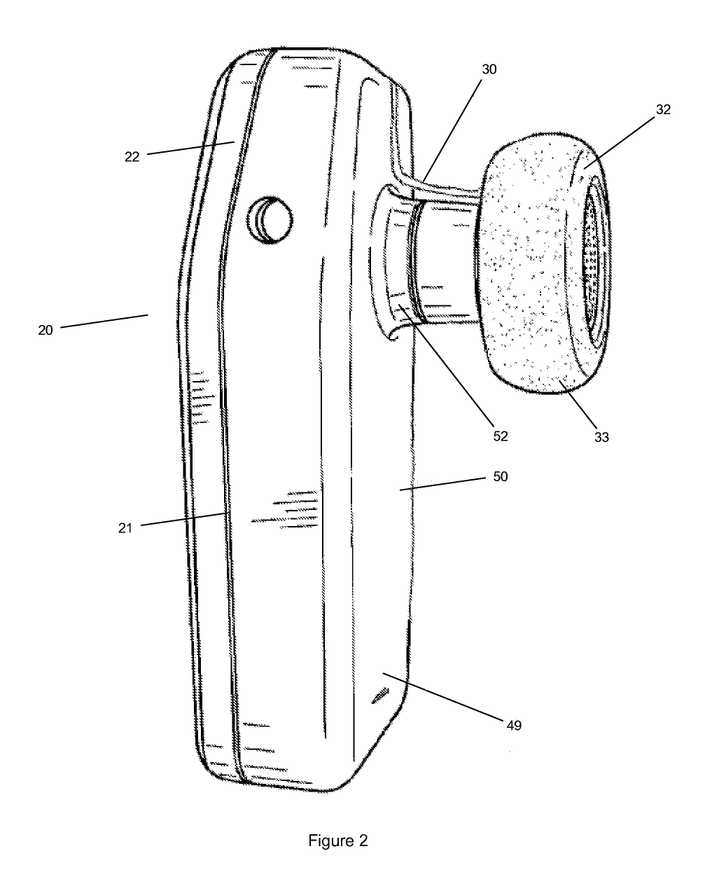

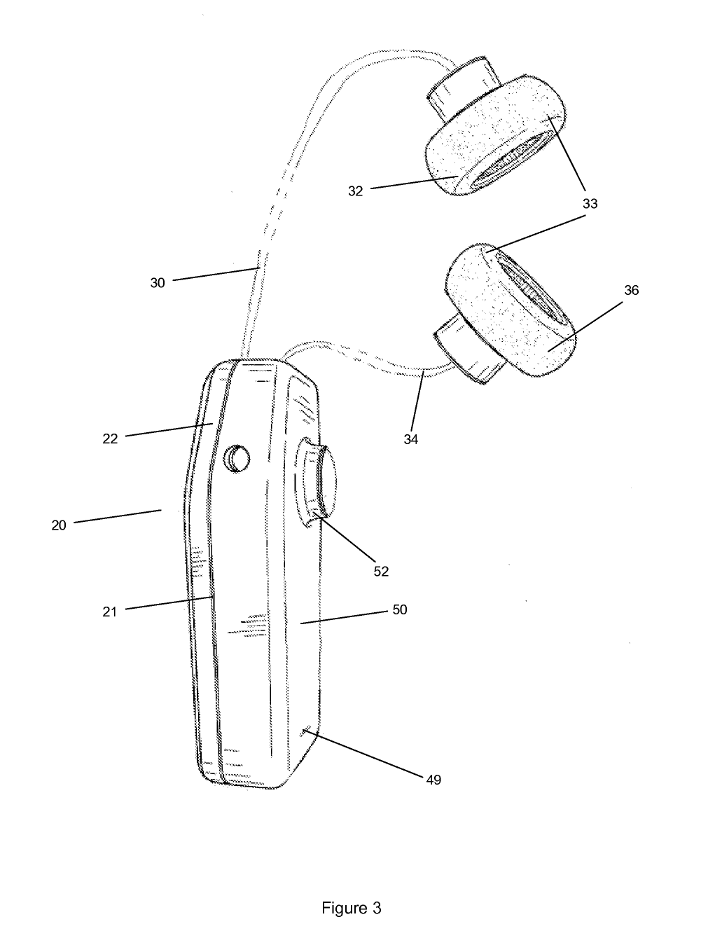

References will be made to FIGS. 1-3 when describing the present invention. FIG. 1 shows a schematic figure of the present invention. FIG. 2 shows a perspective view of a physical embodiment of the present invention in a first mode while FIG. 3 shows a perspective view of the physical embodiment of the present invention in a second mode. It should be noted that FIG. 1 contains features which are not visible from a view of a physical embodiment of the present invention shown in FIGS. 2-3. As such, a combination of the views provided in FIGS. 1-3 provides a complete view of essential features of the present invention. However, it should also be noted that a physical appearance of the physical embodiment of the present invention should not be limited to what is depicted in FIGS. 2-3, and other physical appearances of the physical embodiment of the present invention would still fall within a scope of the present invention.

There is provided a wireless headset 20 as shown in FIGS. 1-3 for enabling communications via a communications apparatus. It should be noted that the wireless headset 20 is not solely for enabling communications as will be evident when describing the wireless headset 20 in subsequent paragraphs. In addition, the communications apparatus may include, for example, mobile telephones, walkie talkies, VoIP devices, and the like. As such, it should be noted that the communications apparatus need not be hand-held and portable.

The wireless headset 20 includes a casing 22 for containing components of the wireless headset 20. The casing 22 should be made of a material which would protect the components of the wireless headset 20. Such a material would typically be, for example, a composite material, a metal, a plastic and so forth. It should be appreciated that the casing 22 may be a primary aspect of the wireless headset 20 which determines an appearance of the wireless headset 20. While the casing 22 is shown to be substantially cuboidal in shape, it is not mandatory for it to be in such a shape. The casing 22 may be in any shape as long as components of the wireless headset 20 are sufficiently protected from external elements and a certain extent of impact forces.

The wireless headset 20 also includes a controller 26 located within the casing 22. The controller 26 is for controlling operations of the wireless headset 20. The controller 26 is able to control the components contained within the casing 22 so as to control the operations of the wireless headset 20. The operations of the wireless headset 20 may include, for example, reception of wireless signals, transmission of wireless signals, volume control for audio output from the wireless headset 20, acceptance of incoming calls, cessation of calls, and so forth.

A wireless transceiver 24 is also located within the casing 22. The wireless transceiver 24 is coupled to the controller 26 such that the wireless transceiver 24 is able to be controlled by the controller 26. The wireless transceiver 24 is for both receiving and transmitting audio data to and from the communications apparatus respectively. The wireless transceiver 24 may employ wireless technology such as, for example, Bluetooth, RF, IR and so forth. It should be appreciated that the received and transmitted audio data may include at least one of voice and music.

There is also an audio driver 28 located within the casing 22. The audio driver 28 is coupled to the controller 26 for output of the received audio data. A first acoustic channel 30 is coupled to the audio driver 28 at a first end 40 of the acoustic channel 30. The first acoustic channel 30 is flexible. The first acoustic channel 30 allows transmission of output from the audio driver 28 to a first ear bud piece 32 coupled to a second end 42 of the first acoustic channel 30. It should be noted that the first acoustic channel 30 is able to have different characteristics which affects the transmission of audio from the audio driver 28. The first acoustic channel 30 may have different characteristics due to varying either a length or a material of the first acoustic channel 30. The first acoustic channel 30 may affect, for example, an extent of phase shifting for the transmitted audio output, an extent of attenuation for the transmitted audio output and so forth.

The first ear bud piece 32 fits within a user's first ear canal. In addition, the first ear bud piece 32 is able to be mounted onto a user-facing surface 50 (during use in a first mode of the wireless headset 20 as shown in FIG. 1) of the casing 22. The first acoustic channel 30 coupled to the first ear bud piece 32 is both coiled and mounted on the casing 22 in the first mode, and both uncoiled and dismounted from the casing 22 in a second mode. While the first ear bud piece 32 is shown to be a foam-encased object 33 which conforms to a diameter of a user's ear canal upon expansion of the foam, it should be appreciated that the first ear bud piece 32 should not be limited to only foam-encased objects. Alternatives may include ear pieces of various shapes and sizes made from either rubber or silicone.

Referring to FIG. 2, it should be noted that the wireless headset 20 is similar in appearance to a typical “in-ear” wireless communications headset in the first mode. In the first mode, the first acoustic channel 30 is coiled in a groove 21 in the casing 22, and the first ear bud piece 32 is mounted on a stand 52 at the user-facing surface 50 of the casing 22. In an alternative embodiment which is not shown, the first acoustic channel 30 may also be coiled using any known cable coiling mechanism which is able to fit within the casing 22. The first ear bud piece 32 is mounted on the stand 52 using, for example, magnetic attraction, friction-fit, snap-fit, screw-fit and so forth.

Referring to FIG. 3, there is shown a representation of the wireless headset 20 in the second mode. It should be noted that the wireless headset 20 is similar in appearance to a typical stereo wireless communications headset in the second mode. In the second mode, the first acoustic channel 30 is uncoiled, and the first ear bud piece 32 is dismounted from the stand 52 at the user-facing surface 50 of the casing 22. There may be a second acoustic channel 34 which is removably 38 coupled to the audio driver 28 at a third end 44 of the second acoustic channel 34. The second acoustic channel 34 may be removably 38 coupled to the audio driver 28 at an opening which both allows transmission of audio signals from the audio driver 28 and is able to hold the second acoustic channel 34 at the opening. The second acoustic channel 34 may be removably 38 coupled to the audio driver 28 using securing mechanisms such as, for example, clips, jack-socket combination, Velcro strips, adhesive strips and so forth.

The second acoustic channel 34 is similar to the first acoustic channel 30. The second acoustic channel 34 is also flexible. The second acoustic channel 34 also allows transmission of output from the audio driver 28 to a second ear bud piece 36 coupled to a fourth end 46 of the second acoustic channel 34. The second ear bud piece 36 also fits within a user's second ear canal. It should be noted that the second acoustic channel 34 is able to have different characteristics which affects the transmission of audio from the audio driver 28. The second acoustic channel 34 may have different characteristics due to varying either a length or a material of the second acoustic channel 34. The second acoustic channel 34 may affect, for example, an extent of phase shifting for the transmitted audio output, an extent of attenuation for the transmitted audio output and so forth.

It should be appreciated that when the second acoustic channel 34 is coupled to the audio driver 28, the user is correspondingly able to listen to audio output via both ears. While the second ear bud piece 34 is shown to be a foam-encased object 33 which conforms to a diameter of the user's ear canal upon expansion of the foam, it should be appreciated that the second ear bud piece 34 should not be limited to only foam-encased objects. Alternatives may include ear pieces of various shapes and sizes made from either rubber or silicone.

The wireless headset 20 also includes a microphone 48 coupled to the controller 26. A slot 49 on the user-facing surface 50 of the casing 22 allows audio signals to be picked up by the microphone 48 which facilitates use of the wireless headset 20 for communications. It should be noted that the microphone 48 is able to pick up audio signals regardless of whether the user-facing surface 50 of the casing 22 is facing the user. It should be noted that the microphone 48 may not be facing the user when the wireless headset 20 is used in the second mode.

It should be noted that during instances of use of the wireless headset 20, the casing 22 is located close to the user's head in the first mode. However, the casing 22 is able to be located a distance away from the user's head in the second mode. When the casing 22 is located a distance away from the user's head, radiation received/transmitted at the wireless transceiver 24 within the casing 22 is advantageously minimized at the user's head. In addition, when the casing 22 is located at a distance away from the user's head, effects from any heat generated within the casing 22 are minimized at the user's head. Moreover, the use of the second ear bud piece 36 together with the use of the first ear bud piece 32 during the second mode also reduces the strain felt at the user's first ear as the weight of the wireless headset 20 is distributed to two ears.

Finally, it should be appreciated that the two modes of the wireless headset 20 allows the wireless headset 20 to be used in a variety of ways, which emphasizes a versatility of the wireless headset 20.

Whilst there has been described in the foregoing description preferred embodiments of the present invention, it will be understood by those skilled in the technology concerned that many variations or modifications in details of design or construction may be made without departing from the present invention.

1. A wireless headset for enabling communications via a communications apparatus, the headset including:
a casing for containing components of the wireless headset;
a controller located within the casing, the controller being for controlling operations of the wireless headset;
a wireless transceiver located within the casing, coupled to the controller for both receiving and transmitting audio data;
an audio driver located within the casing, the audio driver being coupled to the controller for output of the received audio data;
a first acoustic channel coupled to the audio driver at a first end, the first acoustic channel allowing transmission of output from the audio driver; and
a first ear bud piece coupled to a second end of the first acoustic channel, the first ear bud piece being able to be mounted onto a user-facing surface of the casing,
wherein the first acoustic channel is flexible.

2. The wireless headset of claim 1, wherein the casing includes either a groove for coiling the first acoustic channel or a coiling mechanism for the first acoustic channel.

3. The wireless headset of claim 1, wherein the wireless transceiver employs wireless technology selected from a group comprising: Bluetooth, RF, and IR.

4. The wireless headset of claim 1, wherein the first ear bud piece fits within a diameter of a user's first ear canal.

5. The wireless headset of claim 2, wherein the first acoustic channel coupled to the first ear bud piece is both coiled and mounted on the casing in a first mode, and both uncoiled and dismounted from the casing in a second mode.

6. The wireless headset of claim 5, wherein during instances of use of the wireless headset, the casing is located close to a user's head in the first mode, and a distance away from the user's head in the second mode.

7. The wireless headset of claim 6, wherein radiation received/transmitted at the wireless transceiver within the casing is minimized at the user's head in the second mode.

8. The wireless headset of claim 6, wherein effects from any heat generated within the casing are minimized at the user's head in the second mode.

9. The wireless headset of claim 5, wherein the first ear bud piece is mounted on the casing in the first mode using a mounting technique selected from a group comprising: magnetic attraction, friction-fit, snap-fit, and screw-fit.

10. The wireless headset of claim 1, further including a microphone coupled to the controller on the user-facing surface of the casing.

11. The wireless headset of claim 5, further including during the second mode:
a second acoustic channel coupled to the audio driver at a third end of the second acoustic channel; and
a second ear bud piece at a fourth end of the second acoustic channel,
wherein the second ear bud piece fits within a diameter of the user's second ear canal.

12. The wireless headset of claim 11, wherein the second acoustic channel is flexible.
